(19) United States
(12) Patent Application Publication
(10) Pub. No.: US 2016/0228831 A1
(43) Pub. Date: Aug. 11, 2016

(54) LIQUID TRANSFER SYSTEM

(71) Applicant: CLAUSSEN TECHNOLOGY, LLC, NAPLES, FL (US)

(72) Inventors: Gerald B. Saude, New London, MN (US); Steven W. Claussen, Glenwood, MN (US)

(21) Appl. No.: 15/011,949

(22) Filed: Feb. 1, 2016

Related U.S. Application Data
(60) Provisional application No. 62/112,274, filed on Feb. 5, 2015.

(51) Int. Cl. B01F 3/08

(52) U.S. Cl. CPC B01F 3/0803; B01F 3/08

(57) ABSTRACT

A transfer system for receiving and supporting one of a first bulk container and a second bulk container may include a platform apparatus, a measuring vessel apparatus and a connection apparatus. Each of the first and second bulk containers may be configured to hold a solution. The first bulk container may include a first container base having a first cross-sectional area and the second bulk container may include a second container base having a second cross-sectional area different than the first cross-sectional area. The platform apparatus may include a plurality of supports positioned to support either of the first and second bulk containers. The transfer system may also include one or more rinse tubes configured to transfer fluid to the measuring vessel apparatus, the first bulk container, and/or the second bulk container to rinse each of the measuring vessel apparatus, the first bulk container, and/or the second bulk container.

### CROSS-REFERENCE TO RELATED APPLICATIONS

This application claims the benefit of U.S. Provisional Patent Application Ser. No. 62/112,274 filed on Feb. 5, 2015, which is incorporated by reference herein in its entirety.

### BACKGROUND

The present disclosure relates to liquid transfer systems for use with bulk containers in the transportation, storage, and delivery of bulk materials.

The transportation of large quantities of bulk liquids or solids has traditionally been carried out by tanker trucks or the like, whereas smaller quantities thereof have been shipped or transported in conventional 55-gallon drums. However, use of such drums has a number of problems, such as their weight and their tendency to leak, dent, and corrode. Furthermore, there are significant costs associated with the handling, use, and disposal of 55-gallon drums, and there are situations where amounts greater than 55 gallons, but less than that carried by a tanker truck, are needed.

One area, for example, where various quantities of bulk material are often needed is the agricultural industry. Individual production sites in the agricultural industry (e.g. farms) are more numerous and more geographically dispersed than in other industries, and are often relatively remote from major transport arteries. Furthermore, due to the number of sites and their size, intermediate, but generally not tanker-sized, amounts of materials such as fertilizer and crop protection chemicals are often required for each site. Distribution channels for the agricultural industry have evolved to deal with this geographical dispersion through use of a number of intermediaries, and generally there is at least one step in the distribution channel between the original supplier and the agricultural site. This leads to the need to be able to safely transport bulk materials where loading, unloading, and temporary storage may occur repeatedly before delivery and use at a final site.

When bulk material is potentially hazardous, as may be the case for fertilizers or crop protection chemicals, repeated handling of the bulk containers can increase the risk of damage to the containers and potential spills. As most crop protection chemicals have a high price/volume ratio and many may be potentially hazardous if spilled or leaked, container integrity is very important.

Increasingly, volumes of bulk materials such as those used in agriculture are being purchased by end-users in large refillable containers sometimes referred to as shuttles. Many of these shuttles may be more formally referred to as intermediate bulk containers (IBC) and may come in a variety of different sizes. Requirements for these types of containers are outlined in various D.O.T. and F.D.A. regulations, and are specifically described in 49 CFR Section 178. IBCs may include numerous types of designs, including metal IBCs (i.e., those constructed of metal), rigid plastic IBCs (i.e., those constructed of all-plastic material), and composite IBCs (i.e., those that include a rigid outer package enclosing a plastic inner receptacle). IBCs may define a capacity in the range of 100-550 gallons.

IBCs may have an integral pump or connector for an external pump to permit transfer of liquid, and are commonly shipped on a pallet and handled by a forklift. For example, the liquid transfer system may provide a 150 gallon tank that is suspended on a frame, which then delivers material to a 5-10 gallon measuring vessel for mixing into carrier liquid for delivery, typically at an agricultural site.

While a great deal of progress has been made in providing bulk material containers, particularly those suited for intermediate sized amounts of material, many of these containers are still awkward to deliver, and difficult to use.

### SUMMARY

The present invention provides a transfer system and methods of use that can be used to separately receive, support, and/or rinse one or more bulk containers. Specifically, a platform or stand (e.g., an Intermediate Container Platform (ICP)) may support a variety of different sized interchangeable bulk containers (e.g., Intermediate Bulk Containers (IBCs)). The bulk containers may be any type of container or tank that is used for transporting and storing, for example, bulk chemicals (e.g., solutions, fertilizer, etc.). The transfer system may also include a measuring vessel or measuring container that may be fluidly coupled or attached to and removed from each bulk container that is positioned on the platform or stand (e.g., using a quick connect hose or connection apparatus) to transfer solution from the bulk container to the measuring vessel. Each bulk container that is positioned on top of the platform or stand may be removed and replaced with a different bulk container (e.g., of the same or different size). The platform or stand may include a variety of different materials such as, e.g., plastic (e.g., by a mold process) or metal.

The transfer system may also include a flow control apparatus that is fluidly coupled to a storage container configured to store fluid (e.g., liquid, water, etc.) and fluidly coupled to the measuring vessel. The flow control apparatus combines (e.g., mixes) the fluid of the storage container with the bulk chemicals of the measuring vessel at a predetermined ratio (e.g., determined by the volume of fluid present in the storage container and the volume of bulk chemicals in the measuring vessel) to be dispersed out of the flow control apparatus (e.g., to a spraying container). The flow control apparatus may also include a port that may be fluidly coupled to a rinse tube such that the fluid of the storage container may be used to rinse either the bulk container or the measuring vessel to clean any remaining bulk materials therein.

One exemplary transfer system for receiving and supporting one of a first bulk container and a second bulk container may include a platform apparatus, a measuring vessel apparatus, and a connection apparatus. Each of the first and second bulk containers may be configured to hold a solution. The first bulk container may include a first container base having a first cross-sectional area and the second bulk container may include a second container base having a second cross-sectional area greater than the first cross-sectional area. The platform apparatus may include a receiving platform portion, a base platform portion, and one or more sidewalls including a first sidewall extending between the receiving platform portion and the base platform portion and a second sidewall opposing the first sidewall and extending between the receiving platform portion and the base platform portion. The receiving platform portion may be configured to separately receive each of the first and second bulk containers. The platform apparatus may include a first plurality of supports extending along the first sidewall and a second plurality of supports extending along the second sidewall. Each of the first plurality of supports and the second plurality of supports may extend between the receiving platform portion and the base platform portion at a distance inwards from the first and second sidewalls, respectively.

The measuring vessel apparatus may be coupled to the platform apparatus and configured to hold and measure the solution. The measuring vessel apparatus may define a measuring vessel inlet and a measuring vessel outlet. The connection apparatus may extend from a first end connection region to a second end connection region. The connection apparatus may define a passageway configured to transfer fluid between the first end connection region and the second end connection region. The first end connection region may be coupled to the measuring vessel inlet and the second end connection region may be removably couplable to a bulk container outlet of each of the first and second bulk containers. The connection apparatus may be configured to transfer the solution in either of the first or second bulk container to the measuring vessel apparatus.

In one or more embodiments, each of the first and second pluralities of supports may define a center point. The center points of each of the first plurality of supports may define a first support axis and the center points of each of the second plurality of supports may define a second support axis. A support width may be defined between the first support axis and the second support axis. The support width may be less than or equal to a width of each of the first and second bulk containers. In one or more embodiments, the distance inwards from the first and second sidewalls may be measured between the first support axis and the first sidewall and between the second support axis and the second sidewall, respectively. The distance may be between 3 inches and 6 inches.

In one or more embodiments, the transfer system may also include a flow control apparatus. The flow control apparatus may define a flow control inlet, a flow control outlet, and a measuring vessel port therebetween in fluid communication with the measuring vessel outlet. The flow control apparatus may be configured to transport fluid from the flow control inlet to the flow control outlet such that the solution in the measuring vessel apparatus may be moved from the measuring vessel port towards the flow control outlet and mixes with the fluid. In one or more embodiments, the flow control apparatus may also define one or more rinse ports positioned upstream of the measuring vessel port and in fluid communication with the fluid from the flow control inlet before the solution mixes with the fluid. In one or more embodiments, the one or more rinse ports may be positioned upstream or downstream of the measuring vessel port. In one or more embodiments, the transfer system may also include one or more rinse tubes configured to transfer fluid from the one or more rinse ports to the measuring vessel apparatus, the first bulk container when received on the receiving platform portion, or the second bulk container when received on the receiving platform portion to rinse the measuring vessel apparatus, the first bulk container, or the second bulk container. The one or more rinse tubes may include a first rinse tube portion extending from a first rinse tube inlet to a first rinse tube outlet and a second rinse tube portion extending from a second rinse tube inlet to a second rinse tube outlet. Each of the first and second rinse tube inlets may be removably couplable to the one or more rinse ports, the first rinse tube outlet may be removably couplable to a container inlet of either of the first and second bulk containers, and the second rinse tube outlet may be removably couplable to a vessel rinsing inlet of the measuring vessel apparatus.

In one or more embodiments, the transfer system may also include a bulk container nozzle fluidly connected to the first rinse tube outlet and configured to spray fluid into either of the first or second bulk containers. The transfer system may also include a measuring vessel nozzle fluidly connected to the second rinse tube outlet and configured to spray fluid into the measuring vessel apparatus. In one or more embodiments, the connection apparatus may be configurable between an attached configuration and a detached configuration. The second end connection region may be coupled to at least one of the bulk container outlets of the first or second bulk container when the connection apparatus is in the attached configuration such that fluid passes between the bulk container outlet of either of the first or second bulk container and the measuring vessel inlet. The second end connection region need not be coupled to the bulk container outlet of either of the first or second bulk container when the connection apparatus is in the detached configuration. In one or more embodiments, the platform apparatus may include a holding apparatus configured to support the second end connection region when the second end connection region is not coupled to the bulk container outlet of either of the first and second bulk containers.

In one or more embodiments, the bulk container outlet of each of the first and second bulk containers may be positioned on a bulk container surface adjacent the first container base and the second container base, respectively. The platform apparatus may define a platform cavity inward from a plane defined by one of the one or more sidewalls. At least a portion of the measuring vessel apparatus may be positioned in the platform cavity. In one or more embodiments, the transfer system may also include one or more straps configured to secure one of the first and second bulk containers to the platform apparatus. Each of the one or more straps may extend from a first end strap region coupled to the platform apparatus proximate the first sidewall to a second end strap region coupled to the platform apparatus proximate the second sidewall. The first or second bulk container may be positioned between the one or more straps and the receiving platform portion. In one or more embodiments, at least one of the one or more sidewalls of the platform apparatus may include one or more steps configured to allow a user to step thereon.

In one or more embodiments, the transfer system may include an additional platform apparatus that is identical to and stackable on the platform apparatus and may include a receiving platform portion, a base platform portion, and one or more sidewall portions extending between the receiving platform portion of the additional platform apparatus and the base platform portion of the additional platform apparatus. The receiving platform portion of the platform apparatus may be configured to mate with the base platform portion of the additional platform apparatus and the base platform portion of the platform apparatus may be configured to mate with the receiving platform portion of the additional platform apparatus.

Another exemplary transfer system for receiving and supporting one of a first bulk container and a second bulk container may include a platform apparatus, a measuring vessel apparatus, a connection apparatus, a flow control apparatus, and one or more rinse tubes. Each of the first and second bulk containers may be configured to hold a solution. The first bulk container may include a first container base having a first cross-sectional area and the second bulk container may include a second container base having a second cross-sectional area greater than the first cross-sectional area. The platform apparatus may include a receiving platform portion, a base platform portion, and one or more sidewalls extending between the receiving platform portion and the base platform portion. The receiving platform portion may be configured to separately receive each of the first and second bulk containers. The measuring vessel apparatus may be coupled to the platform apparatus and may be configured to hold and measure the solution. The measuring vessel apparatus may define a measuring vessel inlet and a measuring vessel outlet. The connection apparatus may extend from a first end connection region to a second end connection region. The connection apparatus may define a passageway configured to transfer fluid between the first end connection region and the second end connection region. The first end connection region may be coupled to the measuring vessel inlet and the second end connection region may be removably couplable to a bulk container outlet of each of the first and second bulk containers. The connection apparatus may be configured to transfer the solution in either of the first or second bulk container to the measuring vessel apparatus.

The flow control apparatus may define a flow control inlet, flow control outlet, and a measuring vessel port therebetween in fluid communication with the measuring vessel outlet. The flow control apparatus may be configured to transport fluid from the flow control inlet to the flow control outlet such that the solution in the measuring vessel apparatus may be moved from the measuring vessel port towards the flow control outlet and mixes with the fluid. The flow control apparatus may also define one or more rinse ports. The one or more rinse tubes may be configured to transfer fluid from the one or more rinse ports to the measuring vessel apparatus, the first bulk container when received by the platform apparatus, or the second bulk container when received by the platform apparatus to rinse the measuring vessel apparatus, the first bulk container, or the second bulk container. The one or more rinse tubes may include a first rinse tube portion extending from a first rinse tube inlet to a first rinse tube outlet and a second rinse tube portion extending from a second rinse tube inlet to a second rinse tube outlet. Each of the first and second rinse tube inlets may be removably couplable to the one or more rinse ports, the first rinse tube outlet may be removably couplable to a container inlet of either of the first and second bulk containers, and the second rinse tube outlet may be removably couplable to a vessel rinsing inlet of the measuring vessel apparatus.

One exemplary method of using and replacing one of a first bulk container and a second bulk container on a platform apparatus may include providing a platform apparatus, a measuring vessel apparatus, and a connection apparatus. Each of the first and second bulk containers may be configured to hold a solution, wherein the first bulk container may include a first container base having a first cross-sectional area and the second bulk container may include a second container base having a second cross-sectional area greater than the first cross-sectional area. The platform apparatus may include a receiving platform portion, a base platform portion, and one or more sidewalls extending between the receiving platform portion and the base platform portion. The measuring vessel apparatus may be coupled to the platform apparatus, may be configured to hold and measure a solution, and may define a measuring vessel inlet and a measuring vessel outlet. The connection apparatus may extend from a first end connection region to a second end connection region and may define a passageway configured to transfer fluid between the first end connection region and the second end connection region. The first end connection region may be coupled to the measuring vessel inlet.

The method may also include supporting the first bulk container on the receiving platform portion and coupling the second end connection region of the connection apparatus to a bulk container outlet of the first bulk container to fluidly couple the first bulk container to the measuring vessel apparatus. Further, the method may include transferring solution in the first bulk container to the measuring vessel apparatus using the connection apparatus. The method may also include uncoupling the second end connection region from the bulk container outlet of the first bulk container and removing the first bulk container from the receiving platform portion.

The method may further include supporting the second bulk container on the receiving platform portion, coupling the second end connection region of the connection apparatus to a bulk container outlet of the second bulk container to fluidly couple the second bulk container to the measuring vessel apparatus, and transferring solution in the second bulk container to the measuring vessel apparatus using the connection apparatus.

In one or more embodiments, the method may also include transferring fluid through a flow control apparatus from a flow control inlet to a flow control outlet such that the solution in the measuring vessel apparatus may be moved from the measuring vessel outlet through a measuring vessel port of the flow control apparatus towards the flow control outlet and mixes with the fluid. The measuring vessel outlet may be fluidly coupled to the measuring vessel port of the flow control apparatus and may be positioned between the flow control inlet and the flow control outlet. In one or more embodiments, the method may further include rinsing either of the first or second bulk containers using a bulk container rinse tube. The bulk container rinse tube may extend from a container rinse tube inlet removably couplable to one or more rinse ports of the flow control apparatus towards a container rinse tube outlet removably couplable to a container inlet of each of the first and second bulk containers. The fluid may transfer from the flow control inlet through the bulk container rinse tube to rinse either of the first or second bulk containers. In one or more embodiments, the method may also include rinsing the measuring vessel apparatus using a measuring vessel rinse tube. The measuring vessel rinse tube may extend from a measuring vessel rinse tube inlet removably couplable to one or more rinse ports of the flow control apparatus towards a measuring vessel rinse tube outlet removably couplable to a vessel rinsing inlet of the measuring vessel apparatus. The fluid may transfer from the flow control inlet and through the measuring vessel rinse tube to rinse the measuring vessel apparatus.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 is a perspective view of an exemplary embodiment of a platform apparatus.

FIG. 2 is a perspective cross-sectional view taken at line 2-2′ of the platform apparatus shown in FIG. 1.

FIG. 3A is a top view of the platform apparatus shown in FIG. 1 including a cross-sectional outline of a bulk container received on the platform apparatus.

FIG. 3B is a top view of the platform apparatus shown in FIG. 1 including a cross-sectional outline of another bulk container received on the platform apparatus.

FIG. 4 is a perspective view of an exemplary transfer system including the platform apparatus shown in FIG. 1 and an exemplary measuring vessel apparatus.

FIG. 5 is a perspective view of the measuring vessel apparatus shown in FIG. 4.

FIG. 6 is a perspective view of a bulk container received on an exemplary transfer system including a platform apparatus, a measuring vessel, and a connection apparatus.

FIG. 7 is an expanded perspective view of a portion of the transfer system shown in FIG. 6.

FIG. 8 is schematic view of a plurality of measuring vessel apparatus, platform apparatus, and bulk containers received by corresponding platform apparatus in series.

FIG. 9 is a perspective view of the transfer system shown in FIG. 6 and further including a flow control apparatus and a rinse tube.

FIG. 10 is an expanded perspective view of a portion of the transfer system shown in FIG. 9.

FIG. 11 is a perspective view of an exemplary rinse tube for rinsing a measuring vessel apparatus.

FIG. 12 is a perspective view of an exemplary rinse tube for rinsing a bulk container.

FIG. 13 is a perspective view of the exemplary rinse tube shown in FIG. 12 coupled to the bulk container.

FIG. 14 is a perspective view of multiple exemplary platform apparatus stacked on one another.

FIG. 15 is a method of separately supporting, coupling, and transferring solution from different bulk containers on an exemplary platform apparatus.

### DETAILED DESCRIPTION OF EXEMPLARY EMBODIMENTS

In the following detailed description of illustrative embodiments, reference is made to the accompanying figures of the drawing which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

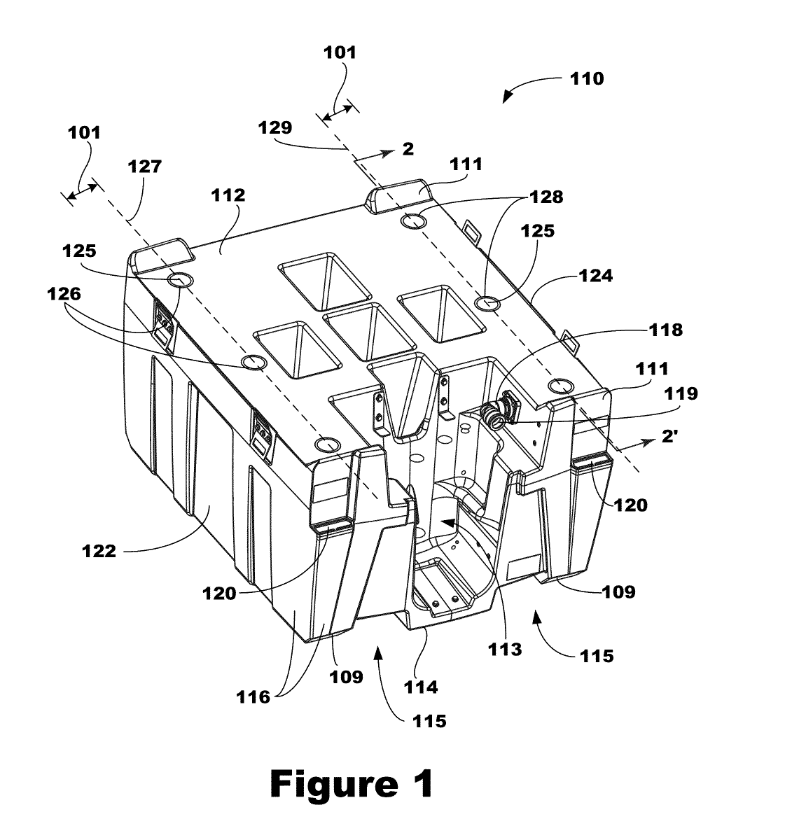

Exemplary apparatus and systems shall be described with reference to FIGS. 1-15. It will be apparent to one skilled in the art that elements from one embodiment may be used in combination with elements of the other embodiments, and that the possible embodiments of such apparatus and systems using combinations of features set forth herein is not limited to the specific embodiments shown in the Figures and/or described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes and/or sizes, or types of elements, may be advantageous over others.

The present disclosure relates generally to transfer systems (e.g., for liquids) and methods for supporting and rinsing bulk containers received on a platform apparatus of the transfer system. The platform apparatus may be configured to receive a variety of different sized bulk containers. The bulk containers may include bulk chemicals or solution that is provided into a measuring vessel apparatus (e.g., by gravity) such that the solution may be combined with a fluid, such as water (e.g., from an additional/storage container), at a predetermined ratio and dispersed into a sprayer container (e.g., a container that stores the mixed water and solution that may be sprayed). The transfer system may also include one or more rinse tubes that transfer fluid (e.g., water from the additional/storage container) to rinse bulk chemical (e.g., residue) from the bulk container or measuring vessel apparatus.

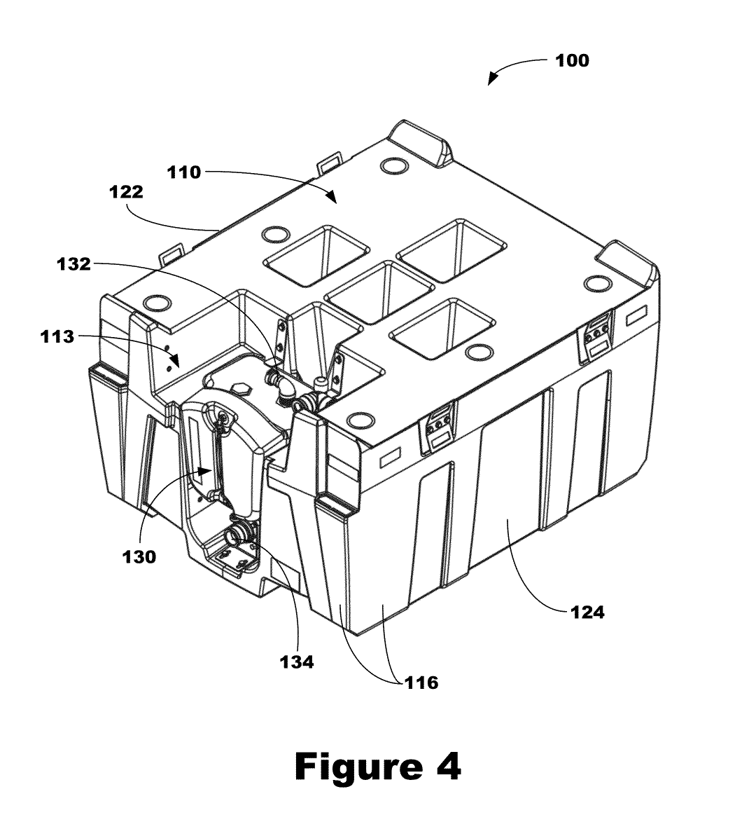

A platform apparatus 110 for a transfer system 100 (see, e.g., transfer system 100 of FIG. 4) for separately receiving and supporting a variety of different bulk containers is shown in FIG. 1. The platform apparatus 110 may be of various shapes and sizes. For example, the platform apparatus 110 may include a receiving platform portion 112 and an opposing base platform portion 114. The receiving platform portion 112 may be configured to receive or support other components, e.g., bulk containers. In other words, components may be positioned on the receiving platform portion 112 on top of the platform apparatus 110. The base platform portion 114 may be configured to support the platform apparatus 110 on a variety of things such as, e.g., the ground, a machine, equipment, another platform apparatus 110, etc.

The platform apparatus 110 may also include one or more sidewalls 116 extending between the receiving platform portion 112 and the base platform portion 114. As shown in FIG. 1, the one or more sidewalls 116 may include a first sidewall 122 (e.g., on the left side) and a second sidewall 124 (e.g., on the right side) opposing the first sidewall 122. Each of the first and second sidewalls 122, 124 extend between the receiving platform portion 112 and the base platform portion 114.

The platform apparatus 110 may include (e.g., be formed of) one or more materials such as, e.g., plastic, metal, fiberglass, epoxy resin, polymer, etc. Additionally, the platform apparatus 110 may be made or formed in a variety of different ways such as, e.g., rotary or spin molding, injection molding, forging, thermoforming, etc. The platform apparatus 110 may include a variety of features such as, e.g., those described in U.S. Pat. App. Pub. No. 2007/0045355 entitled, “Bulk Container with Collapsible Support,” which is hereby incorporated by reference.

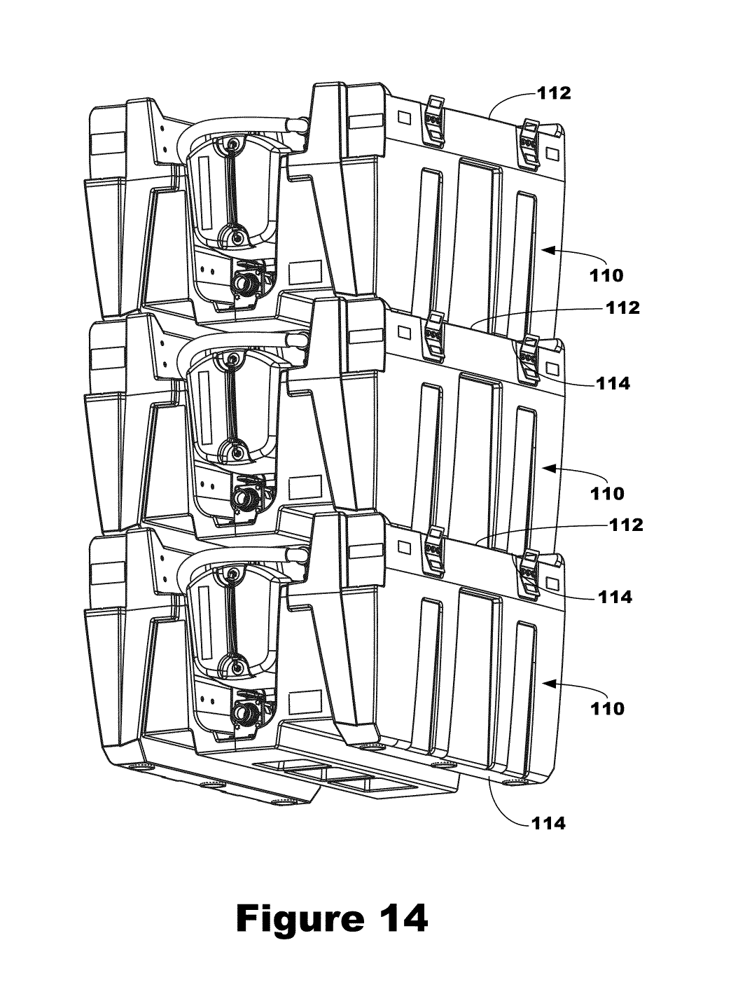

The platform apparatus 110 may include features such that the platform apparatus 110 may be easily transported and readily stacked (e.g., to facilitate transportation of multiple platform apparatus 110). For example, the platform apparatus 110 may be stacked as shown in FIG. 14. Specifically, an additional platform apparatus 110 that is identical to the platform apparatus 110 may be configured such that the receiving platform portion 112 of the platform apparatus 110 may be configured to mate with the base platform portion 114 of the additional platform apparatus 110 and the base platform portion 114 of the platform apparatus 110 may be configured to mate with the receiving platform portion 112 of the additional platform apparatus 110. In other words, the platform apparatus 110 may be configured to be stacked as shown in FIG. 14 for improved storing and/or transportation. As shown in FIG. 1, the platform apparatus 110 may include one or more protrusions 111 configured to accurately position (e.g., nest) any component (e.g., an additional platform apparatus 110, a bulk container 10, etc.) in relation to the platform apparatus 110. The one or more protrusions 111 may be positioned on any part of the platform apparatus 110 and may include any number of protrusions 111. As shown in FIG. 1, the one or more protrusions 111 are positioned proximate the receiving platform portion 112 and include four protrusions 111 at the corners of the receiving platform portion 112.

Additionally, the platform apparatus 110 may define one or more indentations 109 that protrude into (e.g., inward toward the interior of) the platform apparatus 110. The one or more indentations 109 may be positioned proximate the base platform portion 114. The one or more indentations 109 may define a shape that is complementary and receptive to the one or more protrusions 111 such that multiple platform apparatus 110 may be stacked (e.g., nested) on one another in a non-obstructive way. Also, the mating of the one or more protrusions 111 and the one or more indentations 109 may help to restrict movement of the platform apparatus 110 relative to one another when nested or stacked. As shown in FIG. 1, the one or more indentations 109 are positioned proximate the base platform portion 114 and include four indentations 109 at the corners of the base platform portion 114.

The platform apparatus 110 may also define one or more lift channels 115 proximate the base platform portion 114. The one or more lift channels 115 may extend into the platform apparatus 110 towards the receiving platform portion 112. The one or more lift channels 115 may be configured to assist in moving the platform apparatus 110 by, e.g., allowing tines of a forklift to extend within the one or more lift channels 115 to lift the platform apparatus 110. For example, the one or more lift channels 115 may extend along one or both of the first and second sidewalls 122, 124 (e.g., spaced a distance inward therefrom) and define an opening in the sidewall between the first and second sidewalls 122, 124 such that, e.g., the tines of a forklift may be positioned proximate (e.g., under) the base platform portion 114. For example, the one or more lift channels 115 may be aligned in a generally parallel fashion and equidistant from the center of the platform apparatus to allow for entry by forklift tines.

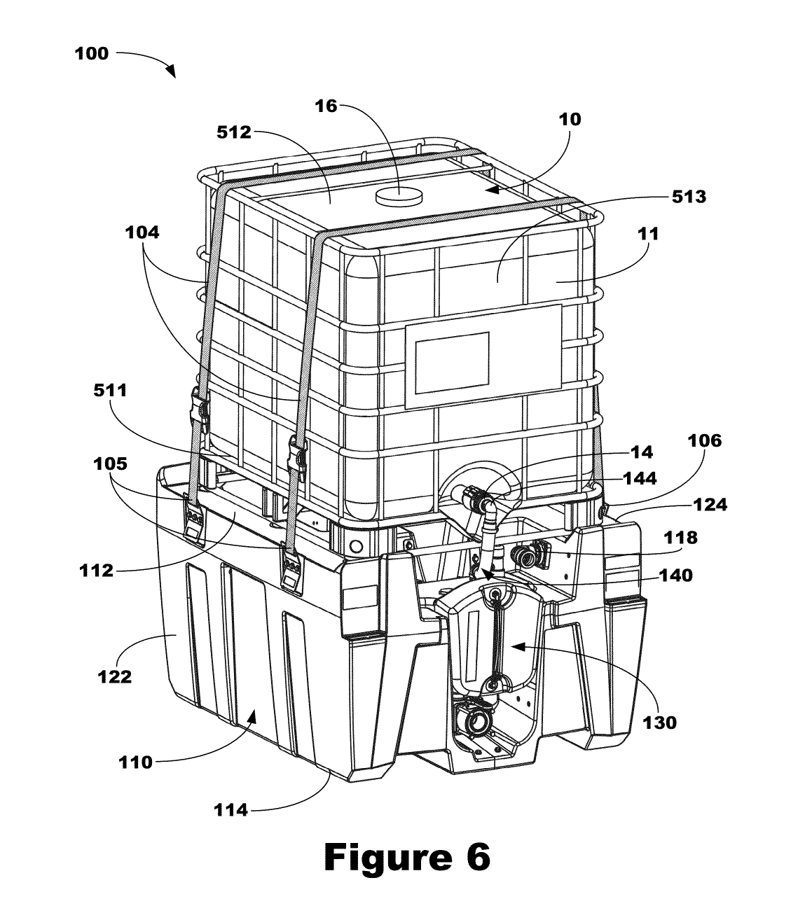

In one or more embodiments, at least one of the one or more sidewalls 116 of the platform apparatus 110 may include one or more steps 120. The one or more steps 120 may be configured to provide a location for an individual to “step-up” and support the weight of the individual to access components that are higher up (e.g., the bulk container 10 as shown in FIG. 6) to, e.g., rinse the bulk container 10, attach or remove components, etc. The one or more steps 120 may be positioned on any suitable portion of the platform apparatus 110. For example, the one or more steps 120 may be proximate the first sidewall 122, the second sidewall 124, a “front sidewall” of the one or more sidewalls 116, e.g., between the first and second sidewall 122, 124, or any combination of the one or more sidewalls 116. The one or more steps 120 may be positioned anywhere along the one or more sidewalls 116 from the receiving platform portion 112 to the base platform portion 114. As shown in FIG. 1, the one or more steps 120 are closer to the receiving platform portion 112 than the base platform portion 114 and define a generally flat surface that lies in a plane that may be generally parallel to the receiving platform portion 112. In one or more embodiments, the one or more steps 120 may include a traction lip that, e.g., provides increased traction to the individual using the one or more steps 120, and/or a draining feature that, e.g., allows any liquid residing in the one or more steps 120 to drain out of the one or more steps 120.

The platform apparatus 110 may also include a plurality of supports 126, 128 configured to strengthen the platform apparatus 110 to, e.g., help support weight added to (e.g., positioned on) the receiving platform portion 112. In one or more embodiments, the plurality of supports 126, 128 may be described as not collapsible under the weight of a bulk container 10 filled with bulk material. The plurality of supports 126, 128 may be provided (e.g., positioned or formed) in a variety of different ways. For example, the platform apparatus 110 may be formed (e.g., spin/rotational molded, injection molded, etc.) around and integral with the plurality of supports 126, 128 such that the plurality of supports 126, 128 are integral with one or both of the receiving platform portion 112 and the base platform portion 114. Additionally, for example, as shown in FIG. 1, the platform apparatus 110 may include a first plurality of supports 126 extending along the first sidewall 122 and a second plurality of supports 128 extending along the second sidewall 124. Each of the first plurality of supports 126 and the second plurality of supports 128 may extend between the receiving platform portion 112 and the base platform portion 114 to, e.g., reinforce compression forces applied between the receiving platform portion 112 and the base platform portion 114. The first plurality of supports 126 and the second plurality of supports 128 may include (e.g., be formed of) one or more materials such as, e.g., plastic, metal, fiberglass, etc.

The first plurality of supports 126 and the second plurality of supports 128 may be described as extending along the first and second sidewalls 122, 124, respectively, at a distance 101 inwards (e.g., an offset) from the first and second sidewalls 122, 124, respectively. In one or more embodiments, the distance 101 inwards may be described as measured from a center point 125 of each of the first plurality of supports 126 and the second plurality of supports 128. For example, each of the first plurality of supports 126 may define a center point 125 and each of the second plurality of supports 128 may define a center point 125. The center points 125 of the first plurality of supports 126 may align to define a first support axis 127 and the center points 125 of the second plurality of supports 128 may align to define a second support axis 129. In one or more embodiments, the distance 101 inwards may be measured between the first sidewall 122 and the first support axis 127 and between the second sidewall 124 and the second support axis 129. As shown in FIG. 1, the first support axis 127 and the second support axis 129 may be parallel to the first sidewall 122 and the second sidewall 124, respectively, however, in one or more embodiments, the first support axis 127 and the second support axis 129 need not be parallel to the first and second sidewalls 122, 124, respectively.

As shown in FIG. 1, the distance 101 inwards, from the corresponding sidewall 122, 124, of each of the first plurality of supports 126 and the second plurality of supports 128 is equivalent. In one or more embodiments, the distance 101 inwards, from the corresponding sidewall 122, 124, of each of the first plurality of supports 126 and the second plurality of supports 128 may be different. The distance 101 may be, e.g., greater than or equal to 1 inch, greater than or equal to 3 inches, greater than or equal to 5 inches and/or less than or equal to 8 inches, less than or equal to 6 inches, less than or equal to 4 inches, etc.

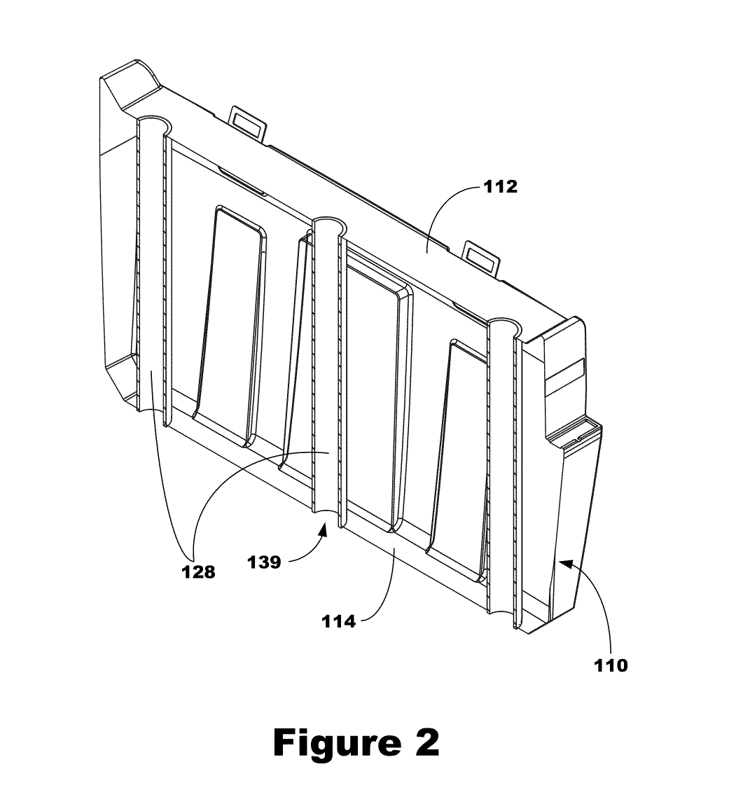

As shown in FIG. 2, a perspective cross-sectional view taken at line 2-2′ of the platform apparatus 110 shown in FIG. 1, the second plurality of supports 128 extend from the receiving platform portion 112 to the base platform portion 114. The second plurality of supports 128 (and, e.g., the first plurality of supports 126) may take any shape or size. As shown in FIG. 2, the second plurality of supports 128 define an annular shape and define a hole 139 through each of the second plurality of supports 128 from the receiving platform portion 112 to the base platform portion 114.

The receiving platform portion 112 may separately receive and support a bulk container 10 defined by one or more bulk container surfaces 11 as shown in FIG. 6. The one or more bulk container surfaces 11 may include a bottom surface 511, a top surface 512 opposite the bottom surface 511, and one or more sidewalls 513. The bulk container 10 is configured to hold a solution (e.g., bulk material) that, e.g., may be mixed with a fluid (e.g., water from a fresh water supply) before aggregating in a sprayer container. The bulk container 10 may include a bulk container outlet 14 (e.g., where the solution exits the bulk container 10) and a bulk container inlet 16 (e.g., where the solution enters the bulk container). The bulk container inlet 16 may be sealed by a cap that is easily attachable and removable. In one or more embodiments, the bulk container outlet 14 may be positioned at a bulk container surface 11 adjacent a surface of the receiving platform portion 112 (e.g., at the one or more sidewalls 513).

The one or more sidewalls 513 of the bulk container surfaces 11 may be positioned generally parallel to the one or more sidewalls 116 of the platform apparatus 110 between the first and second sidewalls 122, 124. The bulk container outlet 14 may be positioned lower on the bulk container 10 than the bulk container inlet 16 (e.g., located on the top surface 512) to facilitate transfer and retention of bulk material by gravity in the bulk container 10. Furthermore, the bulk container outlet 14 may be positioned proximate the bottom surface 511 of the bulk container 10 to facilitate egress of released bulk material by gravity. The bulk container outlet 14 may also include a valve to restrict and allow solution to move from the bulk container 10 to a measuring vessel apparatus 130 of the transfer system 100.

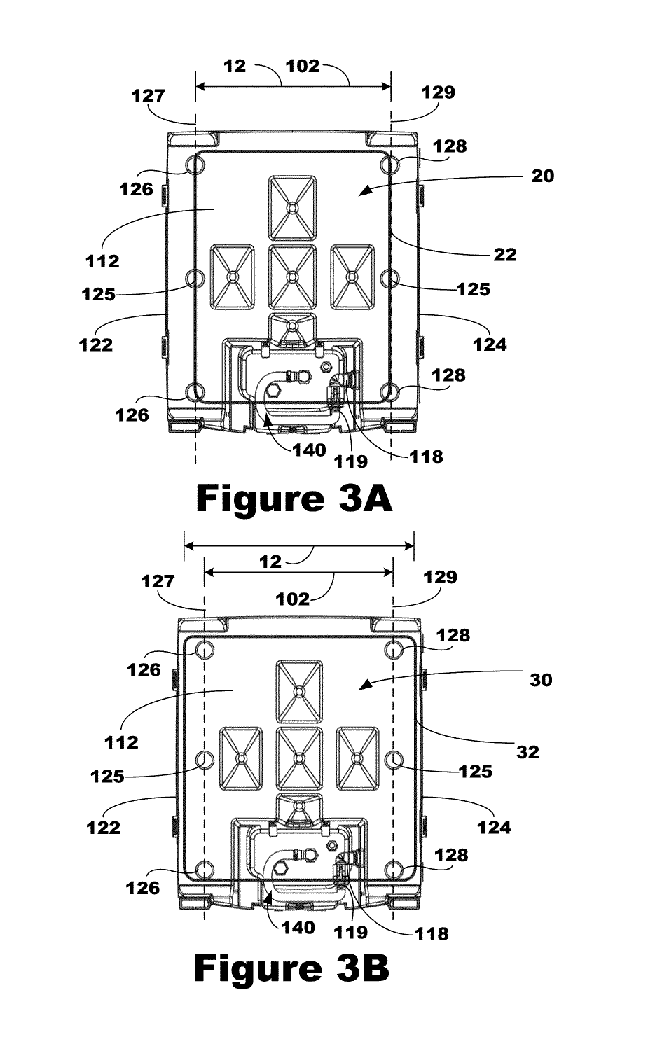

The bulk container 10 may include a variety of different sizes and shapes as illustrated in FIGS. 3A and 3B. The bulk container 10 may be configured to hold various volumes of fluid. For example, the bulk container 10 may define an interior configured to hold greater than or equal to 100 gallons, greater than or equal to 200 gallons, greater than or equal to 250 gallons, greater than or equal to 275 gallons and/or less than or equal to 500 gallons, less than or equal to 400 gallons, less than or equal to 375 gallons, less than or equal to 300 gallons, etc. Each of the different sized and shaped bulk containers 10 may be received and supported by the receiving platform portion 110 separately.

For example, a first bulk container 20 (e.g., as shown transparent in FIG. 3A) may be received by the receiving platform portion 112 and the first bulk container 20 may include a first container base 22 that defines a first cross-sectional area. Further, a second bulk container 30 (e.g., as shown transparent in FIG. 3B) may be received by the receiving platform portion 112 and the second bulk container 30 may include a second container base 32 that defines a second cross-sectional area. In one or more embodiments, the second cross-sectional area of the second container base 32 may be greater than the first cross-sectional area of the first container base 22. The bulk container outlet 14 of each of the first and second bulk containers 20, 30 may be positioned on a bulk container surface 11 that is, e.g., adjacent the first container base 22 and the second container base 32, respectively.

Further, the bulk container 10 may define a variety of shapes and surfaces. For example, the bulk container 10 may define a shape that is cubed, cuboid, “box-like”, pyramidal, coned, sphere-like, cylindrical, etc. Additionally, the bulk container 10 may include a base (e.g., first and second container bases 22, 32) received by the platform apparatus 110 that defines a variety of different shapes (e.g., a cross-section across the base of the bulk container 10). For example, the base of the bulk container 10 may define a shape that is square, rectangular, triangular, circular, etc. The base of the bulk container 10 may also define a bulk container width 12. The bulk container width 12 may be measured between, e.g., points farthest from one another on the base, points on an outer edge of the base, opposing sides of a rectangular base, etc.

For each of the first and second bulk containers 20, 30, the corresponding first and second container bases 22, 32 may overlap at least a portion of each (or, e.g., at least one) of the first plurality of supports 126 and the second plurality of supports 128 when either of the first or second bulk container 20, 30 is received by the platform apparatus 110. As shown in FIG. 3A, the first container base 22 of the first bulk container 20 at least partially covers each of the first plurality of supports 126 and the second plurality of supports 128. For example, the first container base 22 is positioned to extend along the center points 125 of each of the first plurality of supports 126 and the second plurality of supports 128. As shown in FIG. 3B, the second container base 32 of the second bulk container 30 is positioned to cover each of the first plurality of supports 126 and the second plurality of supports 128 such that each of the first plurality of supports 126 and the second plurality of supports 128 may be within a boundary of the second container base 32 (e.g., the second cross-sectional area of the second container base 32).

The first plurality of supports 126 and second plurality of supports 128 may be spaced apart such that the bulk containers 10 positioned on the receiving platform portion 112 (e.g., the first or second bulk container 20, 30) may be supported by each of the first plurality of supports 126 and the second plurality of supports 128 (e.g., each of the first plurality of supports 126 and the second plurality of supports 128 is located underneath something positioned on the receiving platform portion 112). The distance between the first plurality of supports 126 and the second plurality of supports 128 may be described as a support width 102 and may be measured between, e.g., the first support axis 127 and the second support axis 129. The support width 102 may be less than or equal to the bulk container width 12 of any of a plurality of bulk containers 10 (e.g., first bulk container 20 or second bulk container 30 as shown in FIGS. 3A-3B). In other words, the bulk container width 12 may be larger than the support width 102 such that edges of the sidewalls 513 of the bulk container 10 are covering or outside of each of the first plurality of supports 126 and the second plurality of supports 128 when the bulk container 10 is received by the receiving platform portion 112, e.g., as shown in FIG. 3B. Further yet, one edge of the bulk container 10 may be positioned between the first plurality of supports 126 and the first sidewall 122 and/or another edge of the bulk container 10 may be positioned between the second plurality of supports 128 and the second sidewall 124 when the bulk container 10 is received by the receiving platform portion 112.

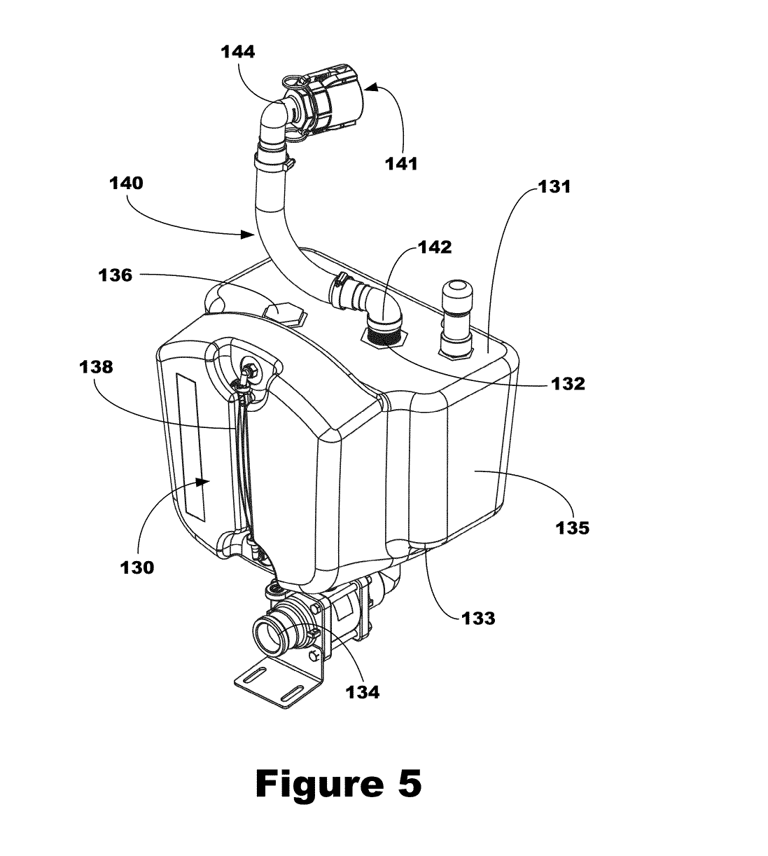

Transfer system 100 may include a measuring vessel apparatus 130, in addition to the platform apparatus 110, as shown in FIGS. 4-5. The measuring vessel apparatus 130 may be configured to hold and measure the solution after solution is transported from the bulk container 10 to the measuring vessel apparatus 130. The measuring vessel apparatus 130 may include a bottom surface 133, a top surface 131 opposite the bottom surface 133, and one or more sidewalls 135. The measuring vessel apparatus 130 may include (e.g., be formed of, etc.) one or more materials such as, e.g., polymer plastic, metal, epoxy resins, polymer, etc. The measuring vessel apparatus 130 may include a variety of different shapes and sizes and may be configured to hold various volumes of fluid. For example, the measuring vessel apparatus 130 may define an interior (e.g., between the top surface 131, bottom surface 133, and the one or more sidewalls 135) configured to hold greater than or equal to 1 gallon, greater than or equal to 5 gallons, greater than or equal to 10 gallons, greater than or equal to 20 gallons and/or less than or equal to 50 gallons, less than or equal to 40 gallons, less than or equal to 25 gallons, less than or equal to 15 gallons, etc. In one or more embodiments, the interior of the measuring vessel apparatus 130 may be configured to hold between 10 and 50 gallons.

The measuring vessel apparatus 130 may measure and hold a predetermined volume of solution that is to be mixed with another fluid (e.g., water) to produce a known ratio between the two fluids, which may then be used to spray for, e.g., agricultural applications. The measuring vessel apparatus 130 may also include a measuring gauge 138 that provides information on the volume of solution (e.g., bulk material) held within the measuring vessel apparatus 130. For example, the measuring gauge 138 may include a transparent or partially transparent tube that runs along the front of the measuring vessel apparatus 130 that includes graduated markings and is fluidly coupled to the interior of the measuring vessel apparatus 130. By matching the level of visible solution with the markings provided on the measuring gauge 138, the amount of solution contained within the measuring vessel apparatus 130 may be determined. The measuring vessel apparatus 130 may define a measuring vessel inlet 132 (e.g., proximate the top surface 131) through which the solution may enter the measuring vessel apparatus 130 and a measuring vessel outlet 134 (e.g., proximate the bottom surface 133) through which the solution may exit the measuring vessel apparatus 130 (e.g., through gravity forcing solution towards measuring vessel outlet 134 proximate the bottom surface 133).

The measuring vessel apparatus 130 may be coupled to the platform apparatus 110 in a variety of different ways and at a variety of different positions. For example, the measuring vessel apparatus 130 may be positioned proximate one of the one or more sidewalls 116 of the platform apparatus 110. As shown in FIG. 4, the measuring vessel apparatus 130 is coupled proximate a sidewall between the first and second sidewalls 122, 124. Further, the platform apparatus 110 may define a platform cavity 113 (e.g., as shown in FIGS. 1 and 4) in the one or more sidewalls 116 (e.g., by deforming at least a portion of a sidewall of the one or more sidewalls 116 to extend inward and toward another sidewall) such that at least a portion of the measuring vessel apparatus 130 may be positioned within a boundary of the platform apparatus 110 defined by planes in which the one or more sidewalls 116 lie (e.g., not including the plane of the deformed sidewall portion of the one or more sidewalls 116). The platform cavity 113 may be defined by one of the sidewalls of the one or more sidewalls 116 that faces the same direction as the bulk container surface 11 (e.g., a surface of the bulk container 10 including the bulk container outlet 14). In other words, the platform cavity 113 may be defined by one of the sidewalls of the one or more sidewalls 116 that is between the first and second sidewall 122, 124 (e.g., the sidewall deforming inward from a plane generally defined by the sidewall that defines the platform cavity 113). The measuring vessel apparatus 130 may be coupled to the platform apparatus using, e.g., fasteners, adhesive, brackets, etc. In one or more embodiments, the platform apparatus 110 may include insert plates, e.g., between the platform apparatus 110 and the measuring vessel apparatus 130, to ensure stability of any fasteners securing the measuring vessel apparatus 130 to the platform apparatus 110 (e.g., in the platform cavity 113).

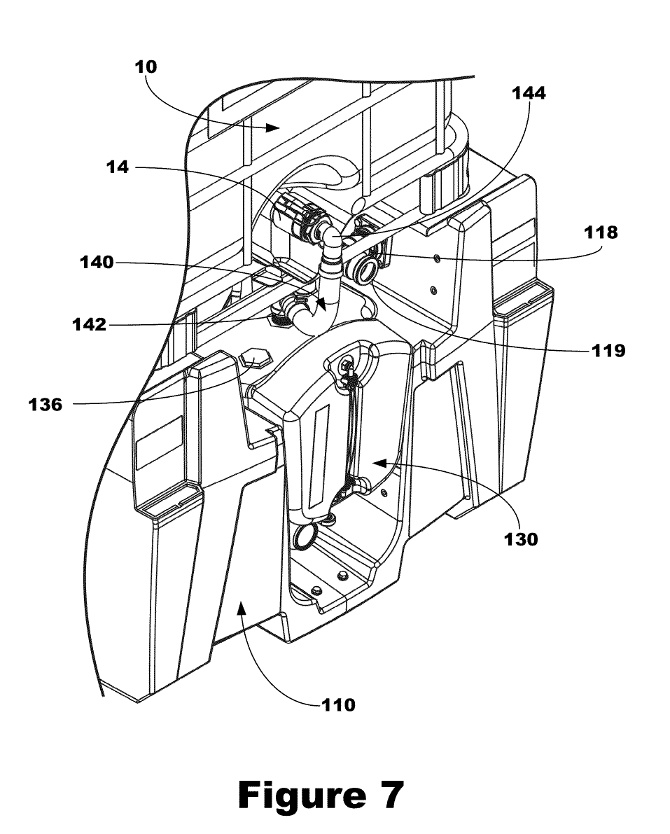

The transfer system 100 may also include a connection apparatus 140 configured to fluidly couple the bulk container 10 to the measuring vessel apparatus 130 as shown in FIG. 5 and, e.g., when the bulk container 10 is received by the platform apparatus 110 as shown in FIGS. 6 and 7. The connection apparatus 140 may extend from a first end connection region 142 to a second end connection region 144 as shown in FIG. 5. The connection apparatus 140 may define a passageway 141 that is configured to transfer fluid between the first end connection region 142 and the second end connection region 144. The connection apparatus 140 may be any suitable component such as, e.g., a tube, a hose, a conduit, etc., that is configured to transfer fluid from one location to another.

The connection apparatus 140 may be positioned such that the first end connection region 142 is coupled to the measuring vessel inlet 132 of the measuring vessel apparatus 130 and the second end connection region 144 is removably couplable to a bulk container outlet 14 of the bulk container 10 (e.g., of each of the first and second bulk containers 20, 30). In other words, the second end connection region 144 may be coupled to and uncoupled from the bulk container outlet 14 of each of the first and second bulk containers 20, 30. The connection apparatus 140 may be configured to transfer the solution in the bulk container 10 (e.g., in either of the first or second bulk container 20, 30) to the measuring vessel apparatus 130. The connection apparatus 140 may be coupled to the bulk container outlet 14 of the bulk container 10 or the measuring vessel inlet 132 of the measuring vessel apparatus 130 in a variety of different ways such as, e.g., snap fit, interference fit, quick connect/release, threads, magnetic connection, etc.

The connection apparatus 140 may be configurable between an attached configuration (e.g., as shown in FIG. 6) and a detached configuration (e.g., as shown in FIGS. 3A and 3B). For example, the second end connection region 144 may be coupled (e.g., fluidly coupled) to the bulk container outlet 14 of the bulk container 10 (e.g., at least one of the bulk container outlets 14 of the first or second bulk container 20, 30) when the connection apparatus 140 is in the attached configuration such that fluid is allowed to pass between the bulk container outlet 14 of the bulk container 10 (e.g., of either of the first or second bulk container 20, 30) and the measuring vessel inlet 132. Also, the second end connection region 144 need not be coupled (e.g., fluidly coupled) to the bulk container outlet 14 of the bulk container 10 (e.g., of either of the first or second bulk container 20, 30) when the connection apparatus 140 is in the detached configuration.

In one or more embodiments, the connection apparatus 140 (e.g., the second end connection region 144) may be positioned relative to the platform apparatus 110 when the second end connection region 144 is not coupled to the bulk container outlet 14 of the bulk container 10 (e.g., when the connection apparatus 140 is in the detached configuration). For example, as shown in FIGS. 1, 6, and 7, the platform apparatus 110 may include a holding apparatus 118 configured to support the second end connection region 144 (e.g., when not coupled to the bulk container outlet 14). In other words, the holding apparatus 118 may position the second end connection region 144 in a known and consistent location when the connection apparatus 140 is not used to transfer fluid (e.g., from the bulk container 10 to the measuring vessel 130).

The holding apparatus 118 may be positioned at any suitable location on the platform apparatus 110. For example, as shown in FIG. 1, the holding apparatus 118 is positioned within the platform cavity 113 and facing forward for access by a user (e.g., towards a “front” facing plane defined by a sidewall between the first and second sidewalls 122, 124). The holding apparatus 118 may include a coupling portion 119 that is configured to be coupled to the second end connection region 144 and may face, e.g., the same direction as the bulk container outlet 14 (e.g., when the bulk container 10 is received by the platform apparatus 110). The coupling portion 119 of the holding apparatus 118 may include any suitable components to couple to the second end connection region 144 such as, e.g., threads, pins, fasteners, etc. Specifically, the second end connection region 144 may couple to the coupling portion 119 of the holding apparatus 118 in a similar manner of coupling the second end connection region 144 to the bulk container outlet 14 as described herein.

As shown in FIG. 6, the transfer system 100 may also include one or more straps 104 configured to secure the bulk container 10 (e.g., one of the first and second bulk containers 20, 30) to the platform apparatus 110 (e.g., on the receiving platform portion 112). Each of the one or more straps 104 extends from a first end strap region 105 coupled to the platform apparatus 110 proximate the first sidewall 122 to a second end strap region 106 coupled to the platform apparatus 110 proximate the second sidewall 124. The first and second end strap regions 105, 106 may include strap holding structures to engage, hold, or otherwise secure the one or more straps 104 in place. The one or more straps 104 may be described as covering or extending over the top surface 512 of the bulk container 10 (e.g., the first or second bulk container 20, 30) and/or that the bulk container 10 (e.g., the first or second bulk container 20, 30) may be positioned between the one or more straps 104 and the receiving platform portion 112. The transfer system 100 may include any number of the one or more straps 104 to secure the bulk container 10 to the platform apparatus 110.

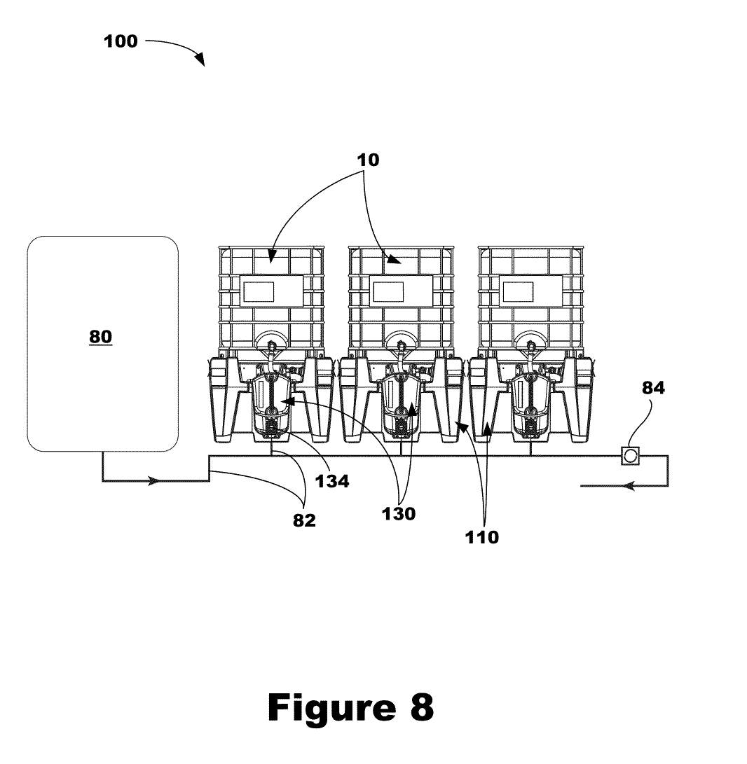

In one or more embodiments, the transfer system 100 may be fluidly connected to a storage container 80 (e.g., storing fluid/liquid) using one or more transfer lines 82, as shown in FIG. 8, such that the fluid in the storage container 80 and the solution in the measuring vessel apparatus 130 mixes or combines and is provided into a spraying container (not shown). A predetermined volume of solution may be located in the measuring vessel apparatus 130 to be mixed with a predetermined volume of fluid from the storage container 80. A valve at the measuring vessel outlet 134 may be configured to control the exit of solution from the measuring vessel apparatus 130 such that the solution may be pulled into and/or mixed with the fluid from the storage container 80.

As shown in FIG. 8, the transfer system 100 may include a pump 84 configured to move the fluid in the storage container 80 and located between the measuring vessel apparatus 130 and the spraying container (not shown). However, the pump 84 may be positioned between the storage container 80 and the measuring vessel apparatus 130 or the measuring vessel apparatus 130 may be positioned between the storage container 80 and the pump 84 (e.g., as shown in FIG. 8). If the pump 84 is positioned between the storage container 80 and the measuring vessel apparatus 130, the pump 84 may be described as configured to pull the fluid from the storage container 80 and push the fluid towards the measuring vessel apparatus 130. The fluid may then, e.g., mix with the solution from the measuring vessel apparatus 130 and the mixture of fluid and solution may move towards a spraying container (not shown). If the measuring vessel apparatus 130 is positioned between the storage container 80 and the pump 84 (e.g., the pump 84 is positioned after the measuring vessel apparatus 130 along the one or more transfer lines 82), the pump may be described as configured to pull fluid from the storage container 80 and solution from the measuring vessel apparatus 130 so that, e.g., the fluid and solution may mix and move towards a spraying container (not shown).

Additionally, as shown in FIG. 8, the transfer system 100 may include a plurality of platform apparatus 110 and a plurality of corresponding bulk containers 10 and measuring vessel apparatus 130. Each of the measuring vessel apparatus 130 may be fluidly coupled to the storage container 80 in series (e.g., in a row) through the one or more transfer lines 82. Each of the measuring vessel apparatus 130 may include a solution (e.g., that is the same as or different from a solution in a different measuring vessel apparatus 130) that is configured to mix with the fluid from the storage container 80. Any number of measuring vessel apparatus 130 may be aligned together to accommodate various configurations of solutions.

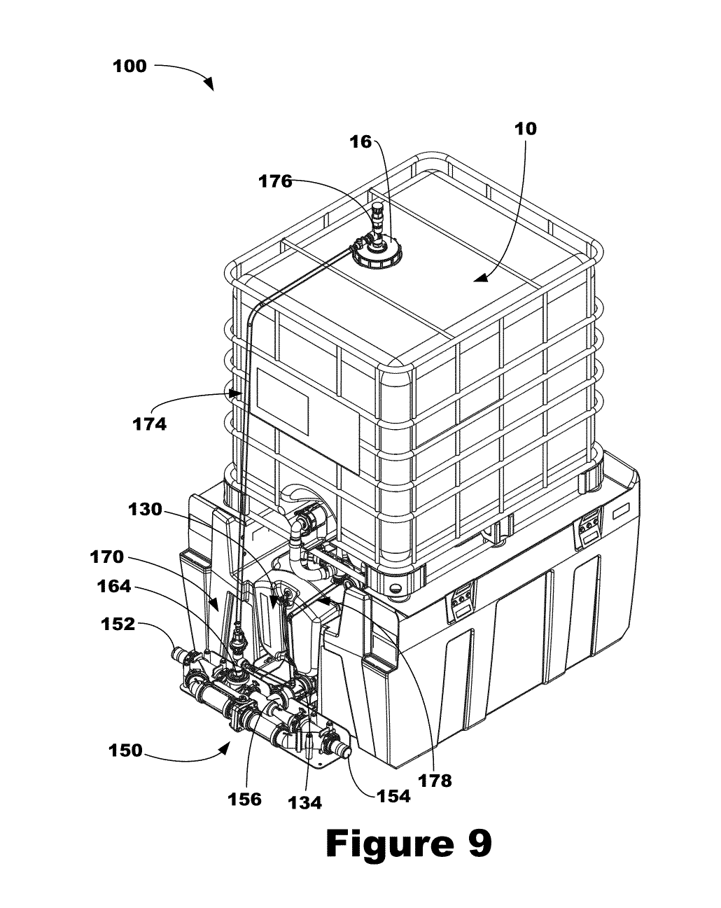

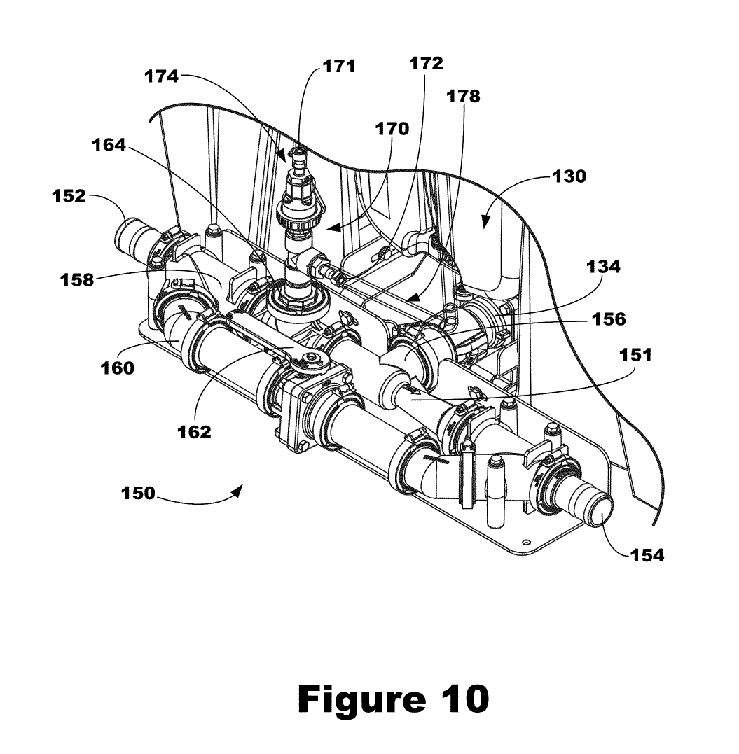

The transfer system 100 may also include a flow control apparatus 150 (e.g., an inductor, an eductor, etc.), as shown in FIGS. 9-10, that may be configured to transport fluid (e.g., from the storage container 80 in FIG. 8, from the measuring vessel apparatus 130, etc.). The flow control apparatus 150 may define a flow control inlet 152, a flow control outlet 154, and a measuring vessel port 156 located between the flow control inlet 152 and the flow control outlet 154. The measuring vessel port 156 may be configured to be in fluid communication with the measuring vessel outlet 134, e.g., when the flow control apparatus 150 (e.g., at the measuring vessel port 156) is coupled to the measuring vessel apparatus 130 (e.g., at the measuring vessel outlet 134). In one or more embodiments, the flow control apparatus 150 may be configured to transport fluid (e.g., from the storage container 80 in FIG. 8) from the flow control inlet 152 to the flow control outlet 154 such that the solution in the measuring vessel apparatus 130 is moved (e.g., by gravity, by vacuum, by suction, etc.) from the measuring vessel port 156 towards the flow control outlet 154 and mixes with the fluid moving through the flow control apparatus 150.

In one or more embodiments, the flow control apparatus 150 may include a venturi 151 positioned between the flow control inlet 152 and the flow control outlet 154. Specifically, e.g., the venturi 151 may be positioned between the flow control inlet 152 and the measuring vessel port 156. The venturi 151 may be configured to create a vacuum in the flow control apparatus 150 such that solution in the measuring vessel apparatus 130 is pulled from the measuring vessel port 156 (e.g., through the measuring vessel outlet 134) and towards the flow control outlet 154. For example, the venturi 151 may create a pressure differential in the flow control apparatus 150 by reducing the cross-section of the flow (e.g., using an orifice) such that the vacuum is created in the flow control apparatus 150. Furthermore, in a transfer system 100 in which a pump 84 is located between the storage container 80 and the measuring vessel apparatus 130, the fluid from the storage container 80 may be pushed past the measuring vessel outlet 134 of the measuring vessel apparatus 130 and the venturi 151 may assist in drawing solution from the measuring vessel apparatus 130 into the stream of fluid from the storage container 80.

In one or more embodiments, e.g., as shown in FIGS. 9-10, the flow control apparatus 150 may include a first flow control portion 158 and a second flow control portion 160 (e.g., a bypass portion). Each of the first and second flow control portions 158, 160 may extend parallel to and separate from the other and from the flow control inlet 152 to the flow control outlet 154. In one or more embodiments, the first flow control portion 158 may include a venturi 151 configured to pull the solution in the measuring vessel apparatus 130 from the measuring vessel port 156 towards the flow control outlet 154. In one or more embodiments, the second flow control portion 160 may include a flow control valve 162 configured to selectively restrict fluid flow through the second flow control portion 160 (e.g., to bypass the first flow control portion 158, which includes the venturi 151). In one or more embodiments, fluid passes through each of the first and second flow control portions 158, 160 when the flow control valve 162 is open. However, the fluid flow rate through the first and second flow control portions 158, 160 may be, e.g., greater than or equal to 200% and/or less than or equal to 500% of the fluid flow rate through the first flow control portion 158. For example, in one or more embodiments, the fluid may flow through only the first control portion 158 (e.g., through the venturi 151) at a rate of 50 gallons/minute and the fluid may flow through both the first and second control portions 158, 160 simultaneously (e.g., with flow control valve 162 open) at a rate of 200 gallons/minute.

The flow control apparatus 150 may also include one or more rinse ports 164 positioned between the flow control inlet 152 and the flow control outlet 154 and in fluid communication with the fluid from the storage container 80 (e.g., through the flow control inlet 152). The one or more rinse ports 164 may be described as a “T-shape” port/outlet between the flow control inlet 152 and the flow control outlet 154, but may take any configuration suitable to provide the fluid flows necessary to provide functionality described herein. Fluid may travel from the flow control inlet 152 and through the one or more rinse ports 164 to, e.g., rinse or clean the bulk container 10 and/or the measuring vessel apparatus 130, e.g., using one or more rinse tubes 170. Due to pressure differentials in the flow control apparatus 150, the fluid may move from the flow control inlet 152 and through the one or more rinse ports 164 unaided (e.g., may not require any additional pumps). The fluid may then travel through the one or more rinse ports 164 to the bulk container 10 and/or the measuring vessel apparatus 130, e.g., using one or more rinse tubes 170. In one or more embodiments, the flow control apparatus 150 may include a valve that allows and/or restricts fluid flow through the one or more rinse ports 164 of the measuring vessel apparatus 130.

The one or more rinse ports 164 may be positioned on either side (e.g., at least one rinse port on each side or all rinse ports on one side) of the measuring vessel port 156, e.g., upstream of the measuring vessel apparatus 130 (e.g., the measuring vessel port 156) or downstream of the measuring vessel apparatus 130 (e.g., the measuring vessel port 156). For example, the one or more rinse ports may be positioned in any one or combination of before the flow control inlet 152, between the flow control inlet 152 and the measuring vessel port 156, between the flow control outlet 154 and the measuring vessel port 156, after the flow control outlet 154, before or after the pump 84 (e.g., the pump 84 shown in FIG. 8), etc. In other words, the one or more rinse ports 164 may be positioned on the flow control apparatus 150 before or after solution from the measuring vessel apparatus 130 enters the flow control apparatus 150 (e.g., at the measuring vessel port 156) and mixes with the fluid. When the one or more rinse ports 164 are located upstream from the measuring vessel apparatus 130, e.g., between the flow control inlet 152 and the measuring vessel port 156, the fluid moving through the one or more rinse ports 164 is not mixed with solution, and therefore, is merely fluid from the storage container 80 (e.g., water). When the one or more rinse ports 164 are located downstream from the measuring vessel apparatus 130, e.g., between the measuring vessel port 156 and the flow control outlet 154, the fluid moving through the one or more rinse ports 164 may be mixed with solution from the measuring vessel apparatus 130, and therefore, is a combination of fluid from the storage container 80 and solution from the measuring vessel apparatus 130. In other words, the location of the one or more rinse ports 164 relative to the measuring vessel port 156 determines whether or not the bulk container 10 and/or the measuring vessel apparatus 130 is rinsed with only fluid from the storage container 80 or a mixture of fluid from the storage container 80 and solution from the measuring vessel apparatus 130.

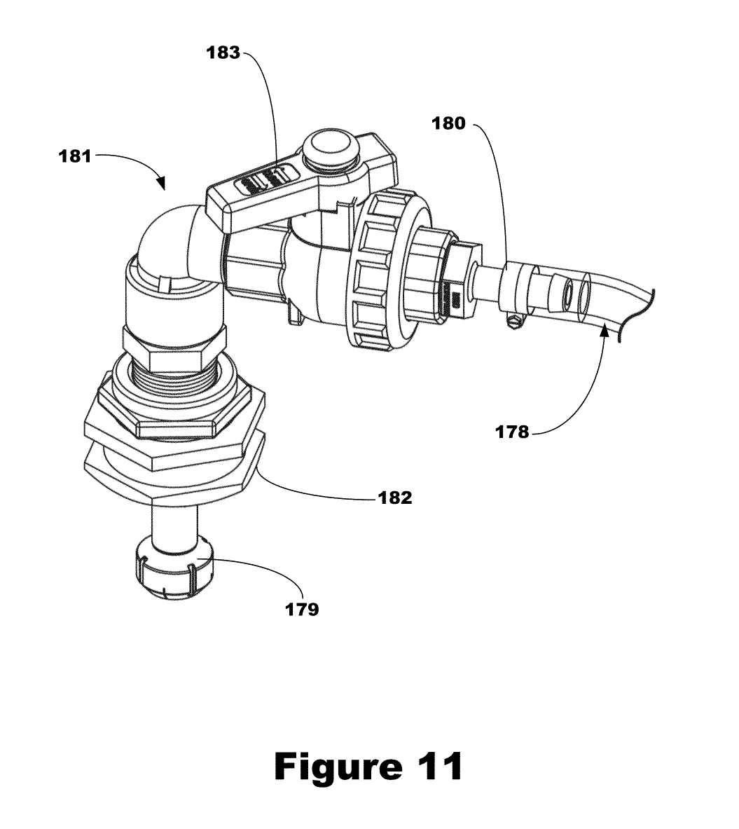

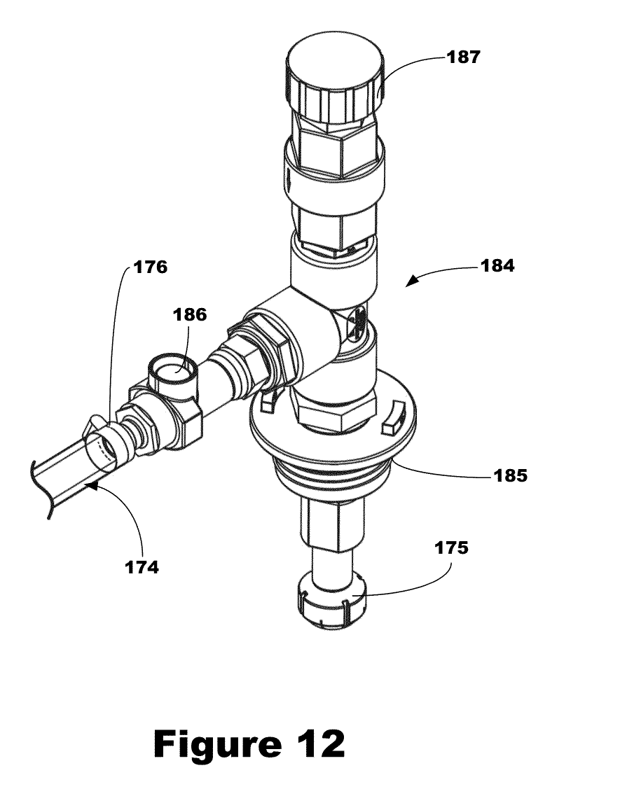

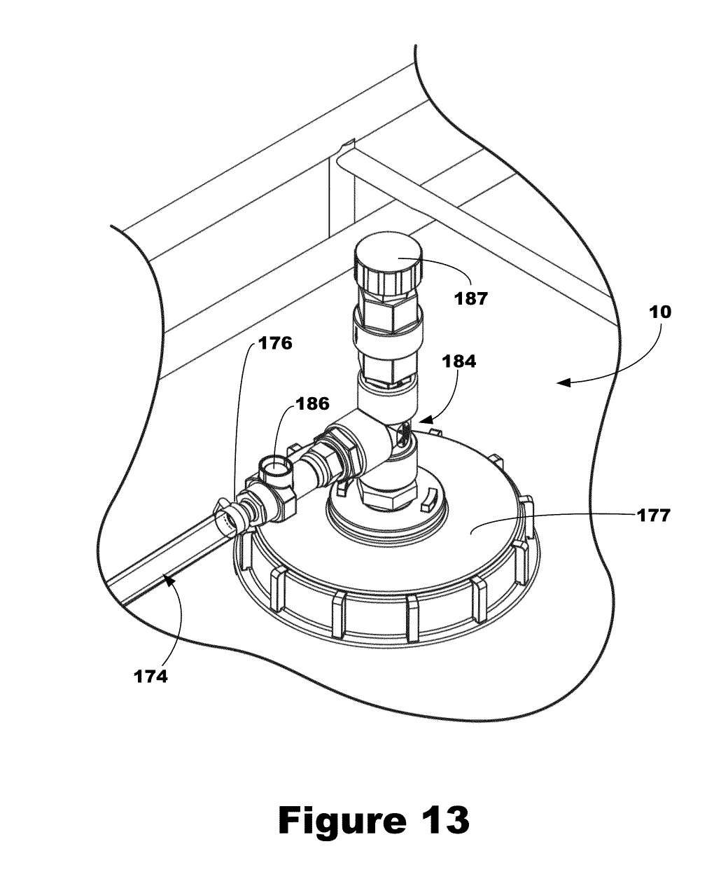

As briefly discussed above, the transfer system 100 may also include one or more rinse tubes 170 configured to transfer fluid from the one or more rinse ports 164 to the bulk container 10 (e.g., when received on the receiving platform portion 112) and/or the measuring vessel apparatus 130 to rinse or clean, e.g., bulk material or residue, out of the bulk container 10 and/or the measuring vessel apparatus 130. The resultant rinsate may then collect in the sprayer container and, e.g., sprayed for agricultural applications to disperse the rinsate. The one or more rinse tubes 170 may include, e.g., a hose that defines an inside diameter of about 0.25 inches, 0.5 inches, 0.75 inches, 1 inch, etc. The one or more rinse tubes 170 may rinse the bulk container 10 and the measuring vessel apparatus 130 simultaneously or separately. For example, the one or more rinse tubes 170 may include a first rinse tube portion 174 (e.g., a bulk container rinse tube) extending from a first rinse tube inlet 171 to a first rinse tube outlet 176 (e.g., as shown in FIGS. 12-13) and a second rinse tube portion 178 (e.g., a measuring vessel rinse tube) extending from a second rinse tube inlet 172 to a second rinse tube outlet 180 (e.g., as shown in FIG. 11). In one or more embodiments, the one or more rinse tubes 170 may include one rinse tube 170 that is bifurcated (e.g., multiple tubes separated by splicers, dividers, tees, branches, etc.) such that the rinse tube 170 is coupled to one rinse port 164 of the one or more rinse ports 164, bifurcates using a tee or any other suitable component, and extends towards two outlets, one outlet for each of the bulk container 10 and the measuring vessel apparatus 130. In other words, the first and second rinse tube inlets 171, 172 are fluidly connected or coupled to the same rinse port 164 of the one or more rinse ports 164. In one or more embodiments, the first and second rinse tube inlets 171, 172 are coupled to separate rinse ports 164 of the one or more rinse ports 164 (that, e.g., may be positioned at various locations).

The first and second rinse tube inlets 171, 172 may be removably couplable to the one or more rinse ports 164 of the flow control apparatus 150. The first rinse tube outlet 176 may be removably couplable to a container inlet 16 of the bulk container 10 (e.g., of either of the first and second bulk containers 20, 30). The second rinse tube outlet 180 may be removably couplable to a vessel rinsing inlet 136 (e.g., as shown in FIG. 5) of the measuring vessel apparatus 130. The one or more rinse tubes 170 may be coupled to the one or more rinse ports 164, container inlet 16, or the vessel rinsing inlet 136, in part, using any suitable connector apparatus such as, a hose clamp and/or a quick connect/coupler. Either of the first and second rinse tube portions 174, 178 may include a valve to allow or restrict flow through the corresponding rinse tube portion 174, 178. Therefore, controlling the valves of each of the first and second rinse tube portions 174, 178 may control whether the first rinse tube portion 174, the second rinse tube portion 178, both the first and second rinse tube portions 174, 178, or neither of the first and second rinse tube portions 174, 178 are being used for rinsing purposes. In one or more embodiments, the valves (e.g., for the bulk container 10, for the measuring vessel apparatus 130, for the flow control apparatus 140, for the one or more rinse tubes 170, etc.) may be manually controlled using, e.g., a handle.

In one or more embodiments, the transfer system 100 may include a measuring vessel connection apparatus 181 to couple and, e.g., fluidly couple, the second tube portion 178 to the measuring vessel apparatus 130, e.g., as shown in FIG. 11. The measuring vessel connection apparatus 181 may include a measuring vessel nozzle 179 on an end of the measuring vessel connection apparatus 181 opposite the second tube portion 178 such that fluid may flow from the second tube portion 178 to the measuring vessel nozzle 179. The measuring vessel nozzle 179 may be configured to spray or disperse fluid into the measuring vessel apparatus 130 to rinse or clean the measuring vessel apparatus 130 of any residual bulk materials. In one or more embodiments, the measuring vessel nozzle 179 may include, e.g., a rotating nozzle, a stationary nozzle, etc. Also, the measuring vessel connection apparatus 181 may include a threaded portion 182 (e.g., at a lid bung) that is configured to couple to the measuring vessel inlet 136. Further, in one or more embodiments, the measuring vessel connection apparatus 181 may include a valve 183 to allow and restrict fluid flow from the second rinse tube portion 178 to the measuring vessel nozzle 179.

In one or more embodiments, the transfer system 100 may include a bulk container connection apparatus 184 to couple the first tube portion 174 to the bulk container, e.g., as shown in FIGS. 12 and 13. The bulk container connection apparatus 184 may include a bulk container nozzle 175 on an end of the bulk container connection apparatus 184 opposite the first rinse tube outlet 176 such that fluid may flow from the first tube portion 174 to the bulk container nozzle 175. The bulk container nozzle 175 may be configured to spray or disperse fluid within the bulk container 10 to rinse or clean the bulk container 10 of any residual bulk materials. In one or more embodiments, the bulk container nozzle 175 may include, e.g., a rotating nozzle, a stationary nozzle, etc. Also, the bulk container connection apparatus 184 may include a threaded portion 185 that is configured to couple to the container inlet 16. Further, as shown in FIG. 13, the transfer system 100 may include an adapter 177 configured to alter the size of the threaded portion 185 such that the bulk container connection apparatus 184 may be coupled to varying sizes of container inlets 16 of the bulk container 10. In one or more embodiments, the bulk container connection apparatus 184 may include a valve port 186 in which a valve (not shown) may be positioned to allow or restrict fluid flow from the first rinse tube portion 174 to the bulk container nozzle 175. The bulk container connection apparatus 184 may also include a release 187 configured to relieve pressure in, e.g., the bulk container connection apparatus 184, the first rinse tube portion 174, the bulk container 10, etc.

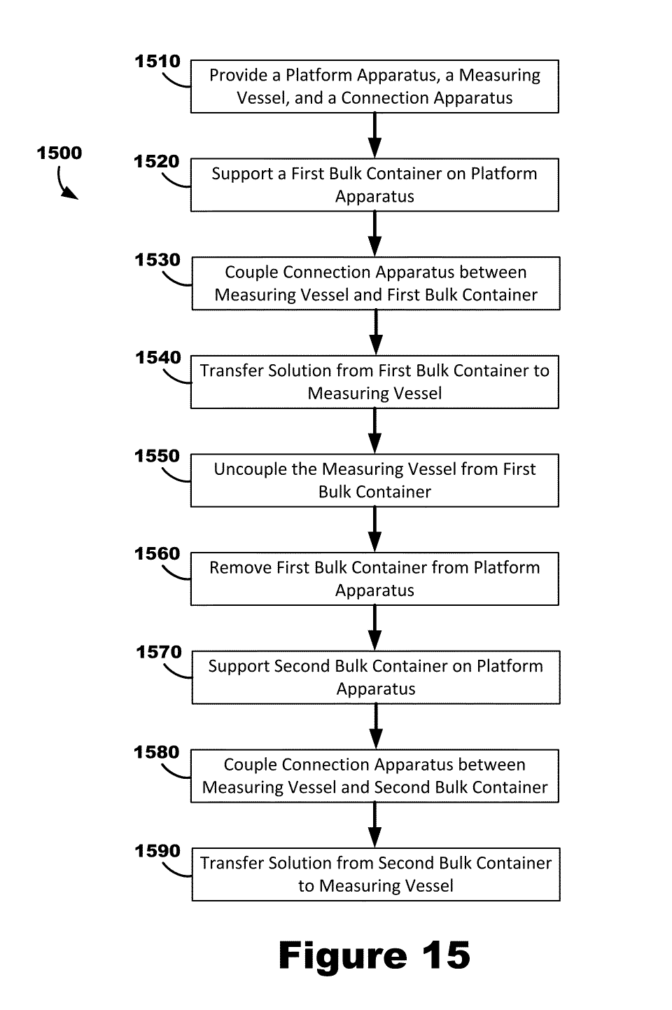

The transfer system 100 may be used for supporting and delivering bulk material from multiple different bulk containers (e.g., bulk containers 10, 20, 30). FIG. 15 illustrates a method 1500 of using and replacing different bulk containers (e.g., a first bulk container 20 or a second bulk container 30) using the transfer system 100. Each of the bulk containers (e.g., the first and second bulk containers 20, 30) may be configured to hold a solution (e.g., a bulk material), as described herein. The solution may be refilled and poured into the bulk container through a bulk container inlet (e.g., bulk container inlet 16) and then secured using a cap. The first bulk container may include a first container base (e.g., first container base 22) having a first cross-sectional area and the second bulk container may include a second container base (e.g., second container base 32) having a second cross-sectional area that may be greater than the first cross-sectional area.

The method 1500 may include providing 1510 a platform apparatus (e.g., platform apparatus 110), a measuring vessel apparatus (e.g., measuring vessel apparatus 130), and a connection apparatus (e.g., connection apparatus 140), as described in further detail herein. For example, the platform apparatus may include a receiving platform portion (e.g., receiving platform portion 112), a base platform portion (e.g., base platform portion 114), and one or more sidewalls (e.g., one or more sidewalls 116) extending between the receiving platform portion and the base platform portion. The measuring vessel apparatus may be coupled to the platform apparatus, configured to hold and measure a solution (e.g., by depositing solution into the measuring vessel apparatus and using a measuring gauge), and define a measuring vessel inlet (e.g., measuring vessel inlet 132) and a measuring vessel outlet (e.g., measuring vessel outlet 134). The connection apparatus may extend from a first end connection region (e.g., first end connection region 142) to a second end connection region (e.g., second end connection region 144) and define a passageway (e.g., passageway 141) configured to transfer fluid between the first end connection region and the second end connection region. The first end connection region may be coupled to the measuring vessel inlet.

The method 1500 may further include supporting 1520 the first bulk container on the receiving platform portion, coupling 1530 the second end connection region to a bulk container outlet (e.g., bulk container outlet 14) of the first bulk container to fluidly couple the first bulk container to the measuring vessel apparatus, and transferring 1540 solution in the first bulk container to the measuring vessel apparatus using the connection apparatus. The solution may flow from the bulk container to the measuring vessel apparatus due to gravity and may be controlled using a valve to restrict or allow fluid to flow from the bulk container.

The method 1500 may also include uncoupling 1550 the second end connection region from the bulk container outlet of the first bulk container (e.g., after use and after closing the valve to the bulk container to prevent leakage) and removing 1560 the first bulk container from the receiving platform portion (e.g., using a forklift or any suitable methods). Further, the method 1500 may include supporting 1570 the second bulk container on the receiving platform portion, coupling 1580 the second end connection region to a bulk container outlet (e.g., bulk container outlet 16) of the second bulk container to fluidly couple the second bulk container to the measuring vessel apparatus, and transferring 1590 solution in the second bulk container to the measuring vessel apparatus using the connection apparatus.

In one or more embodiments, the method 1500 may also include transferring fluid through a flow control apparatus (e.g., flow control apparatus 150, an eductor, an inductor, etc.) from a flow control inlet (e.g., flow control inlet 152) to a flow control outlet (e.g., flow control outlet 154) such that the solution in the measuring vessel apparatus may be moved from the measuring vessel outlet (e.g., when the measuring vessel apparatus valve is opened) through a measuring vessel port (e.g., measuring vessel port 156) of the flow control apparatus towards the flow control outlet and mixes with the fluid. The measuring vessel outlet may be fluidly coupled to the measuring vessel port of the flow control apparatus and positioned between the flow control inlet and the flow control outlet. The fluid may travel from a storage container (e.g., storage container 80) to the fluid control inlet under pressure from, e.g., a pump (e.g., pump 84). In one or more embodiments, moving the solution from the measuring vessel outlet to the flow control outlet may include creating a vacuum between the measuring vessel outlet and the flow control outlet using a venture (e.g., venturi 151) positioned between the flow control outlet and the flow control inlet. The vacuum in the venturi may “pull” the solution out of the measuring vessel apparatus and towards the flow control outlet.

In one or more embodiments, the method 1500 may also include rinsing either of the first or second bulk containers using a bulk container rinse tube (e.g., first rinse tube portion 174). The bulk container rinse tube may extend from a container rinse tube inlet (e.g., first rinse tube inlet 171) towards a container rinse tube outlet (e.g., first rinse tube outlet 176). The container rinse tube inlet may be removably couplable to one or more rinse ports (e.g., one or more rinse ports 164) of the flow control apparatus and the container rinse tube outlet may be removably couplable to a container inlet (e.g., bulk container inlet 16) of each of the first and second bulk container. The fluid may transfer from the flow control inlet through the bulk container rinse tube to rinse either of the first or second bulk containers. The rinse fluid (or rinsate) may then travel with any residue solution through the measuring vessel and out the flow control apparatus towards a spraying container.

In one or more embodiments, the method 1500 may further include rinsing the measuring vessel apparatus using a measuring vessel rinse tube (e.g., second rinse tube portion 178). The measuring vessel rinse tube may extend from a measuring vessel rinse tube inlet (e.g., second rinse tube inlet 172) to a measuring vessel rinse tube outlet (e.g., second rinse tube outlet 180). The measuring vessel rinse tube inlet may be removably couplable to one or more rinse ports (e.g., one or more rinse ports 164) of the flow control apparatus and the measuring vessel rinse tube outlet may be removably couplable to a vessel rinsing inlet of the measuring vessel apparatus. The fluid may transfer from the flow control inlet and through the measuring vessel rinse tube to rinse the measuring vessel apparatus. The rinse fluid (or rinsate) may then travel with any residue solution through the measuring vessel and out the flow control apparatus towards a spraying container.

The forgoing description, accompanied by drawings that form a part of the description hereof, show illustrations of various embodiments. It is to be understood that other embodiments are contemplated and may be made without departing from the scope of the present disclosure. The detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Particular materials and dimensions thereof recited in the disclosed examples, as well as other conditions and details, should not be construed to unduly limit this disclosure. Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

What is claimed is:

1. A transfer system for receiving and supporting one of a first bulk container and a second bulk container, wherein each of the first and second bulk containers is configured to hold a solution, wherein the first bulk container comprises a first container base having a first cross-sectional area and the second bulk container comprises a second container base having a second cross-sectional area greater than the first cross-sectional area, wherein the transfer system comprises:
a platform apparatus comprising a receiving platform portion, a base platform portion, and one or more sidewalls comprising a first sidewall extending between the receiving platform portion and the base platform portion and a second sidewall opposing the first sidewall and extending between the receiving platform portion and the base platform portion, wherein the receiving platform portion is configured to separately receive each of the first and second bulk containers, wherein the platform apparatus comprises a first plurality of supports extending along the first sidewall and a second plurality of supports extending along the second sidewall, wherein each of the first plurality of supports and the second plurality of supports extend between the receiving platform portion and the base platform portion at a distance inwards from the first and second sidewalls, respectively;
a measuring vessel apparatus coupled to the platform apparatus and configured to hold and measure the solution, wherein the measuring vessel apparatus defines a measuring vessel inlet and a measuring vessel outlet; and
a connection apparatus extending from a first end connection region to a second end connection region, wherein the connection apparatus defines a passageway configured to transfer fluid between the first end connection region and the second end connection region, wherein the first end connection region is coupled to the measuring vessel inlet and the second end connection region is removably couplable to a bulk container outlet of each of the first and second bulk containers, wherein the connection apparatus is configured to transfer the solution in either of the first or second bulk container to the measuring vessel apparatus.

2. The transfer system of claim 1, wherein each of the first and second pluralities of supports define a center point, wherein the center points of each of the first plurality of supports define a first support axis and the center points of each of the second plurality of supports define a second support axis, wherein a support width is defined between the first support axis and the second support axis, wherein the support width is less than or equal to a width of each of the first and second bulk containers.

3. The transfer system of claim 1, wherein each of the first and second pluralities of supports define a center point, wherein the center points of each of the first plurality of supports define a first support axis and the center points of each of the second plurality of supports define a second support axis, wherein the distance inwards from the first and second sidewalls is measured between the first support axis and the first sidewall and between the second support axis and the second sidewall, respectively, wherein the distance is between 3 inches and 6 inches.

4. The transfer system of claim 1, further comprising a flow control apparatus defining a flow control inlet, a flow control outlet, and a measuring vessel port therebetween in fluid communication with the measuring vessel outlet, wherein the flow control apparatus is configured to transport fluid from the flow control inlet to the flow control outlet such that the solution in the measuring vessel apparatus is moved from the measuring vessel port towards the flow control outlet and mixes with the fluid.

5. The transfer system of claim 4, wherein the flow control apparatus further defines one or more rinse ports positioned upstream of the measuring vessel port and in fluid communication with the fluid from the flow control inlet before the solution mixes with the fluid.

6. The transfer system of claim 4, wherein the flow control apparatus further defines one or more rinse ports positioned upstream or downstream of the measuring vessel port, wherein the transfer system further comprises one or more rinse tubes configured to transfer fluid from the one or more rinse ports to the measuring vessel apparatus, the first bulk container when received on the receiving platform portion, or the second bulk container when received on the receiving platform portion to rinse the measuring vessel apparatus, the first bulk container, or the second bulk container, wherein the one or more rinse tubes comprise a first rinse tube portion extending from a first rinse tube inlet to a first rinse tube outlet and a second rinse tube portion extending from a second rinse tube inlet to a second rinse tube outlet, wherein each of the first and second rinse tube inlets is removably couplable to the one or more rinse ports, the first rinse tube outlet is removably couplable to a container inlet of either of the first and second bulk containers, and the second rinse tube outlet is removably couplable to a vessel rinsing inlet of the measuring vessel apparatus.

7. The transfer system of claim 6, further comprising a bulk container nozzle fluidly connected to the first rinse tube outlet and configured to spray fluid into either of the first or second bulk containers, wherein the transfer system further comprises a measuring vessel nozzle fluidly connected to the second rinse tube outlet and configured to spray fluid into the measuring vessel apparatus.

8. The transfer system of claim 1, wherein the connection apparatus is configurable between an attached configuration and a detached configuration, wherein the second end connection region is coupled to at least one of the bulk container outlets of the first or second bulk container when the connection apparatus is in the attached configuration such that fluid passes between the bulk container outlet of either of the first or second bulk container and the measuring vessel inlet, and wherein the second end connection region is not coupled to the bulk container outlet of either of the first or second bulk container when the connection apparatus is in the detached configuration.

9. The transfer system of claim 1, wherein the platform apparatus comprises a holding apparatus configured to support the second end connection region when the second end connection region is not coupled to the bulk container outlet of either of the first and second bulk containers.

10. The transfer system of claim 1, wherein the bulk container outlet of each of the first and second bulk containers is positioned on a bulk container surface adjacent the first container base and the second container base, respectively, wherein the platform apparatus defines a platform cavity inward from a plane defined by one of the one or more sidewalls, wherein at least a portion of the measuring vessel apparatus is positioned in the platform cavity.

11. The transfer system of claim 1, further comprising one or more straps configured to secure one of the first and second bulk containers to the platform apparatus, wherein each of the one or more straps extends from a first end strap region coupled to the platform apparatus proximate the first sidewall to a second end strap region coupled to the platform apparatus proximate the second sidewall, wherein the first or second bulk container is positioned between the one or more straps and the receiving platform portion.

12. The transfer system of claim 1, further comprising an additional platform apparatus that is identical to and stackable on the platform apparatus and comprises a receiving platform portion, a base platform portion, and one or more sidewall portions extending between the receiving platform portion of the additional platform apparatus and the base platform portion of the additional platform apparatus, wherein the receiving platform portion of the platform apparatus is configured to mate with the base platform portion of the additional platform apparatus and the base platform portion of the platform apparatus is configured to mate with the receiving platform portion of the additional platform apparatus.

13. The transfer system of claim 1, wherein at least one of the one or more sidewalls of the platform apparatus comprises one or more steps configured to allow a user to step thereon.

14. A transfer system for receiving and supporting one of a first bulk container and a second bulk container, wherein each of the first and second bulk containers is configured to hold a solution, wherein the first bulk container comprises a first container base having a first cross-sectional area and the second bulk container comprises a second container base having a second cross-sectional area greater than the first cross-sectional area, wherein the transfer system comprises:
a platform apparatus comprising a receiving platform portion, a base platform portion, and one or more sidewalls extending between the receiving platform portion and the base platform portion, wherein the receiving platform portion is configured to separately receive each of the first and second bulk containers;
a measuring vessel apparatus coupled to the platform apparatus and configured to hold and measure the solution, wherein the measuring vessel apparatus defines a measuring vessel inlet and a measuring vessel outlet;
a connection apparatus extending from a first end connection region to a second end connection region, wherein the connection apparatus defines a passageway configured to transfer fluid between the first end connection region and the second end connection region, wherein the first end connection region is coupled to the measuring vessel inlet and the second end connection region is removably couplable to a bulk container outlet of each of the first and second bulk containers, wherein the connection apparatus is configured to transfer the solution in either of the first or second bulk container to the measuring vessel apparatus;
a flow control apparatus defining a flow control inlet, flow control outlet, and a measuring vessel port therebetween in fluid communication with the measuring vessel outlet, wherein the flow control apparatus is configured to transport fluid from the flow control inlet to the flow control outlet such that the solution in the measuring vessel apparatus is moved from the measuring vessel port towards the flow control outlet and mixes with the fluid, wherein the flow control apparatus further defines one or more rinse ports; and
one or more rinse tubes configured to transfer fluid from the one or more rinse ports to the measuring vessel apparatus, the first bulk container when received by the platform apparatus, or the second bulk container when received by the platform apparatus to rinse the measuring vessel apparatus, the first bulk container, or the second bulk container, wherein the one or more rinse tubes comprises a first rinse tube portion extending from a first rinse tube inlet to a first rinse tube outlet and a second rinse tube portion extending from a second rinse tube inlet to a second rinse tube outlet, wherein each of the first and second rinse tube inlets is removably couplable to the one or more rinse ports, the first rinse tube outlet is removably couplable to a container inlet of either of the first and second bulk containers, and the second rinse tube outlet is removably couplable to a vessel rinsing inlet of the measuring vessel apparatus.

15. A method of using and replacing one of a first bulk container and a second bulk container on a platform apparatus, wherein each of the first and second bulk containers is configured to hold a solution, wherein the first bulk container comprises a first container base having a first cross-sectional area and the second bulk container comprises a second container base having a second cross-sectional area greater than the first cross-sectional area, the method comprising:
providing a platform apparatus, a measuring vessel apparatus, and a connection apparatus, wherein the platform apparatus comprises a receiving platform portion, a base platform portion, and one or more sidewalls extending between the receiving platform portion and the base platform portion, wherein the measuring vessel apparatus is coupled to the platform apparatus, configured to hold and measure a solution, and defines a measuring vessel inlet and a measuring vessel outlet, wherein the connection apparatus extends from a first end connection region to a second end connection region and defines a passageway configured to transfer fluid between the first end connection region and the second end connection region, wherein the first end connection region is coupled to the measuring vessel inlet;
supporting the first bulk container on the receiving platform portion;
coupling the second end connection region of the connection apparatus to a bulk container outlet of the first bulk container to fluidly couple the first bulk container to the measuring vessel apparatus;
transferring solution in the first bulk container to the measuring vessel apparatus using the connection apparatus;
uncoupling the second end connection region from the bulk container outlet of the first bulk container;
removing the first bulk container from the receiving platform portion;
supporting the second bulk container on the receiving platform portion;
coupling the second end connection region of the connection apparatus to a bulk container outlet of the second bulk container to fluidly couple the second bulk container to the measuring vessel apparatus; and
transferring solution in the second bulk container to the measuring vessel apparatus using the connection apparatus.

16. The method of claim 15, further comprising transferring fluid through a flow control apparatus from a flow control inlet to a flow control outlet such that the solution in the measuring vessel apparatus is moved from the measuring vessel outlet through a measuring vessel port of the flow control apparatus towards the flow control outlet and mixes with the fluid, wherein the measuring vessel outlet is fluidly coupled to the measuring vessel port of the flow control apparatus and positioned between the flow control inlet and the flow control outlet.

17. The method of 15, further comprising rinsing either of the first or second bulk containers using a bulk container rinse tube, wherein the bulk container rinse tube extends from a container rinse tube inlet removably couplable to one or more rinse ports of the flow control apparatus towards a container rinse tube outlet removably couplable to a container inlet of each of the first and second bulk containers, wherein the fluid transfers from the flow control inlet through the bulk container rinse tube to rinse either of the first or second bulk containers.

18. The method of 15, further comprising rinsing the measuring vessel apparatus using a measuring vessel rinse tube, wherein the measuring vessel rinse tube extends from a measuring vessel rinse tube inlet removably couplable to one or more rinse ports of the flow control apparatus towards a measuring vessel rinse tube outlet removably couplable to a vessel rinsing inlet of the measuring vessel apparatus, wherein the fluid transfers from the flow control inlet and through the measuring vessel rinse tube to rinse the measuring vessel apparatus.
